(19) United States
(12) Patent Application Publication
(10) Pub. No.: US 2026/0297313 A1
(43) Pub. Date: Oct. 1, 2026

(54) RUBBER COMPOSITION, AND ASSOCIATED FORMULATION METHOD AND PARTS

(71) Applicant: AIRBOSS OF AMERICA CORP., Newmarket (CA)

(72) Inventors: Ali VAHIDIFAR, Newmarket (CA); Steven YU, Newmarket (CA)

(21) Appl. No.: 19/474,754

(22) PCT Filed: Apr. 11, 2024
(86) PCT No.: PCT/IB2024/053561

§ 371 Date: Oct. 13, 2025

Related U.S. Application Data
(60) Provisional application No. 63/458,676, filed on Apr. 12, 2023.

(51) Int. Cl. C08L 23/16; B32B 7/12; B32B 15/06; B32B 17/10; C08J 5/12; C08K 3/34

(52) U.S. Cl. CPC C08L 23/16; B32B 7/12; B32B 15/06; B32B 17/10; C08J 5/124; C08K 3/34; C08K 3/346; B32B 2250/02; C08J 2323/16; C08J 2423/16; C08J 2463/00; C08J 2475/00; C08K 2003/343; C08L 2205/025

(57) ABSTRACT

A high surface energy (HSE) rubber compound contains EPDM. The compound may include a hygroscopic inorganic filler and/or calcium oxide. An article contains an HSE rubber composition adhered to a substrate with an adhesive. The substrate may include metal or glass. The adhesive may be an epoxy adhesive or a polyurethane adhesive.

This application claims priority to U.S. Provisional Application Ser. No. 63/458,676, filed Apr. 12, 2023, the contents of which are incorporated by reference herein.

### BACKGROUND

EPDM rubber materials have a wide range of properties, including high stability in harsh environments, suitable elasticity and strength, good thermal and weathering resistance, and low cost, which make them advantageous for use in various fields, such as profiles, hoses, cable seals, roofing membranes, seal for doors and windows in automotive and building, covering in irrigation systems, gaskets for water systems and others. However, EPDM rubber's high inertness, low surface energy, and low wettability pose significant challenges for adhesion to other materials as reactive adhesives, like epoxy or polyurethane, cannot effectively bond to it.

Several surface treatment techniques such as chemical (halogenation, addition, etching, and oxidation), photochemical (oxidative and nonoxidative degradation, halogenation, and photografting), and physical (corona discharge, flame, plasma, electron, and ion beam treatments) have been successfully employed to increase the surface energy of elastomers and enhance adhesive rubber bonds. They use similar reactions such as surface oxidation (resulting in new carbonyl and carboxyl groups), nitrization, and increased surface roughness to enhance EPDM rubber's surface energy, wettability, and EPDM/adhesive adhesion.

EPDM modification techniques can lead to reduced thermal, aging, and mechanical properties due to significant changes in its stable chemistry, limited increase in surface energy, and unstable treatment effects plus they add complexity to process and increasing final product costs.

It would be desirable to develop new EPDM compositions with high surface energy and without requiring such modification techniques.

### BRIEF DESCRIPTION

Disclosed, in some embodiments, are high surface energy EPDM compounds.

Disclosed, in other embodiments, are methods of formulating high surface energy EPDM compounds.

Disclosed, in further embodiments, are methods of using high surface energy EPDM compounds.

In non-limiting embodiments, a high surface energy EPDM rubber composition includes: from about 0 to about 90 phr of a first EPDM polymer having a Mooney viscosity measured at 125° C. in the range of 70 to 80, and/or an ethylene content in a range of about 60 to 73%, and/or a diene content in a range of about 4.5 to 6.8%; and from about 10 to about 100 phr of a second EPDM polymer having a Mooney viscosity measured at 125° C. in the range of 80 to 90, and/or an ethylene content in a range of about 50 to 60%, and/or a diene content in a range of about 7 to 9.5%.

The high surface energy EPDM rubber composition may further contain: from about 100 to about 300 phr of a highly hygroscopic inorganic filler. The hygroscopic inorganic filler may be included in an amount of about from 150 to about 230 phr.

The high surface energy EPDM rubber composition may further contain: calcium oxide. The calcium oxide is optionally included in an amount of from about 5 to about 30 phr.

In non-limiting embodiments, an article includes the high surface energy EPDM adhered to a substrate with an adhesive.

Non-limiting examples of substrates include glass, a metals, and metal alloys.

Non-limiting examples of adhesives include epoxy adhesives and polyurethane adhesives.

In non-limiting embodiments, a high surface energy EPDM rubber composition includes: an EPDM polymer having a Mooney viscosity measured at 125° C. in the range of 80 to 90, and/or an ethylene content in a range of about 50 to 60%, and/or a diene content in a range of about 7 to 9.5%; a highly hygroscopic inorganic filler; and calcium oxide.

Non-limiting examples of dienes include ENB.

In non-limiting embodiments, a high surface energy EPDM rubber composition contains an EPDM polymer having a Mooney viscosity measured at 125° C. in the range of 80 to 90, and/or an ethylene content in a range of about 50 to 60%, and/or a diene content in a range of about 7 to 9.5%. The diene may be ENB and/or the composition may further include a highly hygroscopic inorganic filler (e.g., from the family of kaolin, talc, or clay).

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 includes photographs showing the extrudability of HSE EPDM compounds with: a 2 mm ribbon (a and b) and a Garvey die (c and d).

FIG. 2 is a photograph showing extruded samples in a shelf-life study.

FIG. 3 includes photographs showing results of peel testing for an untreated reference compound, a treated reference compound, and three high surface energy compounds.

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

Where a plurality of ranges are disclosed, the upper and lower limits of each range may be combined with the limits of the other ranges.

The present disclosure relates to high surface energy (HSE) EPDM rubber compositions. These unique compounds have an exceptionally high surface energy level, with a minimum of 40 dynes/cm (e.g., at least 58 dynes/cm), which is higher than all known rubbers and at least twice as high as a typical EPDM compound. HSE EPDMs without treatment can also exhibit a 25% higher surface energy than treated common EPDMs at about 60 dynes/cm. HSE EPDMs have outstanding wettability and strong bond strength with a wide range of adhesives (such as urethanes, epoxies, and others), without requiring any surface modifications or treatments. For example, the peeling test of HSE EPDMs was about twice of that for treated EPDM and more than four times higher than untreated EPDM. Using HSE EPDMs eliminates the need for surface treatment of rubbers to increase surface energy and bonding to coatings, which helps reduce the cost of the final application. High wettability, good processability, and low compression set make HSE EPDM compounds ideal for rubber-metal and rubber-glass bonding in automotive and building gaskets needs polyurethane or epoxy adhesives.

A diene of the EPDM may be from the group consisting of 5-vinylidene-2-norbornene (VNB), 5-methylene-2-norbornene (MNB), 5-ethylidene-2-norbornene (ENB), 5-butyl-2-norbornene (BNB), 5-Crotyl-2-norbornene (CrNB), 5-Methallyl-2-norbornene (MANB), 5-isopropylidene-2-norbornene (IPNB), 5-Methyl-5-vinyl-2-norbornene (MeVNB), 5-Propenyl-2-norbornene (PNB), dicyclopentadiene (DCPD), and a combination of any two or more thereof. In particular embodiments, the diene is or includes ENB.

The diene monomer content may be in a range of about 0.01 wt % to about 10 wt % (e.g., 2.8 wt %). In some embodiments, the diene monomer content is at least 7 wt %, including from 7 wt % to about 9.5 wt %.

In some embodiments, the ethylene content is at least 40 wt %, including from 56 wt % to 75 wt % and from 56 wt % to 60 wt %.

In some embodiments, the EPDM composition further includes one or more oils (e.g., paraffinic oil). The total oil content may be in a range of about 20 to about 250 phr, including from about 30 to about 150 phr, about 50 to about 100 phr, about 60 to about 90 phr, about 70 to about 80 phr, and about 75 phr.

The EPDM composition may further include one or more carbon blacks. The carbon black may be in the range of 15 nm and 350 nm such as N110, N220, N330, N550, N660, N770 N990 carbon black, in some embodiments, depending on mechanical property requirements.

The EPDM composition may further include one or more fillers. In particular embodiments, the one or more fillers include a inorganic filler. Optionally, the filler is selected from metal oxides, metal carbonates, metal hydroxides, metal nitrates, metal sulfides and ceramics such as aluminium oxides, magnesium oxide, barium oxide, silicon oxide, copper, calcium, iron oxide, lead, nickel, mica, zinc or silica and/or silicates (e.g., magnesium silicate). Optionally, the filler is from the family of kaolin, talc, or clay. Surface treated silica, clay, talc, and/or kaolin may also be included. An amount of the highly hygroscopic inorganic filler may be in a range of about 50 to about 400 phr, including about 100 to about 700 phr, about 125 to about 300 phr, and about 150 to about 230 phr.

In some embodiments, the EPDM rubber composition further includes stearic acid and/or lauric acid. The stearic and/or lauric acid may assist in rubber vulcanization.

The EPDM composition may further include zinc oxide and/or other vulcanization activators.

In some embodiments, the EPDM composition further includes one or more activators. The activator(s) may be present in a total amount of from about 0 to about 20 phr, including from about 1 to about 10 phr, about 2 to about 8 phr, about 3 to about 7 phr, and about 5 phr.

Optionally, the EPDM composition further includes calcium oxide. Calcium oxide may function to absorb moisture in the formulation. The calcium oxide may be included in an amount of from about 0 to about 20 phr, including from about 5 to about 15 phr, and about 10 phr.

The EPDM composition may further include one or more silane monomers. The silane content may be in a range of about 0 phr to about 20 phr (e.g., 5 phr). In some embodiments, the silane content is about 1 phr to about 15 phr, including about 2 phr to about 10 phr, about 3 phr to about 7 phr, and about 4 phr to about 6 phr.

In some embodiments, the EPDM composition further includes one or more processing aids. Non-limiting examples of processing aids include fatty acids, metal soaps and/or derivatives thereof (e.g., STRUKTOL® Aflux 42 and WS 18). The total amount of processing aid(s) may be in a range of about 0 to about 10 phr, including from about 0.5 to about 5 phr, about 1 to about 5 phr, about 1.5 to about 3 phr, and about 2 phr.

One or more silane agents may be utilized. Non-limiting examples include silazanes, siloxanes and alkoxysilanes. Alkoxysilane can be selected from alkylsilanes; acryl-based silanes; vinyl-based silanes; aromatic silanes; epoxy-based silanes; amino-based silanes, ureide-based silanes; and mercapto-based silanes.

Silazane may include hexamethyldisilazane (HMDS) or bis(trimethylsilyl)amine.

Siloxanes such as polydimethylsiloxane (PDMS) and octamethylcyclotetrasiloxane are also contemplated.

Non-limiting examples of acryl-based silanes include beta-acryloxyethyl trimethoxysilane; beta-acryloxy propyl trimethoxysilane; gamma-acryloxyethyl trimethoxysilane; gamma-acryloxypropyl trimethoxysilane; beta-acryloxyethyl triethoxysilane; beta-acryloxypropyl triethoxysilane; gamma-acryloxyethyl triethoxysilane; gamma-acryloxypropyl triethoxysilane; beta-methacryloxyethyl trimethoxysilane; beta-methacryloxypropyl trimethoxysilane; gamma-methacryloxyethyl trimethoxysilane; gamma-methacryloxypropyl trimethoxysilane; beta-methacryloxyethyl triethoxysilane; beta-methacryloxypropyl triethoxysilane; gamma-methacryloxyethyl triethoxysilane; gamma-methacryloxypropyl triethoxysilane; and 3-methacryloxypropylmethyl diethoxysilane.

Non-limiting examples of vinyl-based silanes include vinyl trimethoxysilane; vinyl triethoxysilane; p-styryl trimethoxysilane, methylvinyldimethoxysilane, vinyldimethylmethoxysilane, divinyldimethoxysilane, vinyltris(2-methoxyethoxy) silane, and vinylbenzylethylenediaminopropyltrimethoxysilane.

Non-limiting examples of aromatic silanes include phenyltrimethoxysilane and phenyltriethoxysilane.

An epoxy-based silane may be selected from 3-glycydoxypropyl trimethoxysilane; 3-glycydoxypropylmethyl diethoxysilane; 3-glycydoxypropyl triethoxysilane; 2-(3,4-epoxycyclohexyl)ethyl trimethoxysilane, and glycidyloxypropylmethyldimethoxysilane.

Non-limiting examples of amino-based silanes include 3-aminopropyl triethoxysilane; 3-aminopropyl trimethoxysilane; 3-aminopropyldimethyl ethoxysilane; 3-aminopropylmethyldiethoxysilane; 4-aminobutyltriethoxysilane; 3-aminopropyldiisopropyl ethoxysilane; 1-amino-2-(dimethylethoxysilyl) propane; (aminoethylamino)-3-isobutyldimethyl methoxysilane; N-(2-aminoethyl)-3-aminoisobutylmethyl dimethoxysilane; (aminoethylaminomethyl) phenetyl trimethoxysilane; N-(2-aminoethyl)-3-aminopropylmethyl dimethoxysilane; N-(2-aminoethyl)-3-aminopropyl trimethoxysilane; N-(2-aminoethyl)-3-aminopropyl triethoxysilane; N-(6-aminohexyl)aminomethyl trimethoxysilane; N-(6-aminohexyl)aminomethyl trimethoxysilane; N-(6-aminohexyl)aminopropyl trimethoxysilane; N-(2-aminoethyl)-1,1-aminoundecyl trimethoxysilane; 1,1-aminoundecyl triethoxysilane; 3-(m-aminophenoxy) propyl trimethoxysilane; m-aminophenyl trimethoxysilane; p-aminophenyl trimethoxysilane; (3-trimethoxysilylpropyl) diethylenetriamine; N-methylaminopropylmethyl dimethoxysilane; N-methylaminopropyl trimethoxysilane; dimethylaminomethyl ethoxysilane; (N,N-dimethylaminopropyl) trimethoxysilane; (N-acetylglycysil)-3-aminopropyl trimethoxysilane, N-phenyl-3-aminopropyltrimethoxysilane, N-phenyl-3-aminopropyltriethoxysilane, phenylaminopropyltrimethoxysilane, aminoethylaminopropyltrimethoxysilane, and aminoethylaminopropylmethyldimethoxysilane.

Non-limiting examples of ureide-based silanes include 3-ureidepropyl triethoxysilane.

A mercapto-based silane may be selected from 3-mercaptopropylmethyl dimethoxysilane, 3-mercaptopropyl trimethoxysilane, and 3-mercaptopropyl triethoxysilane.

Also contemplated are polysiloxanes with (1) vinyl, alkyl and ethoxy groups, or (2) containing vinyl and ethoxy groups.

The EPDM composition may further include one or more antioxidants. In some embodiments, multiple antioxidants are included. The antioxidant(s) may be present in a total amount of from about 0 to about 20 phr, including from about 1 to about 10 phr, about 2 to about 5 phr, and about 3 phr.

The antioxidant may be a para phenylenediamines (PPD), a phosphate antioxidant, a trimethyl-dihydroquinoline (TMQ) (optionally having a molecular weight of at least 519, at least 692, or at least 865)), a phenolic antioxidant, and an alkylated diphenyl amine (DPA).

Non-limiting examples include N-alkyl-N′-aryl-p-phenylenediamine (e.g., 6PPD, IPPD, CPPD, 8PPD); N,N′-diaryl-p-phenylenediamine (e.g., DPPD, DTPD); N,N′-dialkyl-p-phenylenediamine (e.g., 77PD, 88PD); 6-Ethoxy-2,2,4-trimethyl-1,2-dihydroquinoline (ETMQ), a mono-functional phenols (Type 1) such as: styrenated phenol or butylated hydroxytoluene; a bi-functional phenols (Type 2) such as: 2.2′-methylenebis (6-t-butyl-4methyl phenol) antioxidant and 4,4′-thiobis-6-(t-butyl metacresol); a multi-functional phenols (Type 3); WINGSTAY® L (Butylated reaction product of p-cresol and dicyclopentadiene), pentaerythritol tetrakis(3-(3,5-di-tert-butyl-4-hydroxyphenyl); a styrenated diphenyl amine (SDPA); an octylated diphenyl amines (ODPA); a heptylated diphenyl amines; a nonylated diphenyl amine; trinonyl phosphate; tris (nonyl phenyl) phosphite (TNPP); diphenylamine-ketone condensates (ADPA); phenyl-α-napthyl amine (PBN); a zinc salt of 1,2-Mercapto-4 (5)-methylbenzimidazole (ZMMBI); 1,2-Mercapto-4 (5)-methylbenzimidazole (MMBI); didodecyl 3.3′ thiodipropionate; dioctadecyl 3.3′ thiodipropionate; zinc dibutyl dithiocarbamate (ZDBC); and nickel dibutyl dithiocarbamate (NBC) or (NiDBC).

The EPDM rubber composition may further include one or more waxes. Non-limiting examples include paraffin waxes and microcrystalline waxes. In some embodiments, a blend of paraffin and microcrystalline waxes is utilized. The total amount of wax(es) may be in a range of from about 0 to about 20 phr, including from about 1 to about 10 phr, about 2 to about 5 phr, and about 3 phr.

In some embodiments, the EPDM rubber composition further contains one or more processing aids.

The EPDM rubber composition may further include a cure package. The sulfur cure system may include one or more materials selected from dithiocarbamates, guanidines, sulfenamides, thiurams, thiazoles, thioureas, phenoldisulfides, and thiadiazoles. Non-limiting embodiments, of dithiocarbamates include zinc diethyl dithiocarbamate (ZDEC) and zinc dibenzyl dithiocarbamate (ZBEC). Non-limiting examples of thiazoles include 2-mercapto benzothiazole (MBT) and 2,2-dithiobis(benzothiazole) (MBTS). In some embodiments, the cure package contains one or more peroxides. The peroxide content may be in a range of about 0.1 phr to about 8 phr (e.g., 0.1 phr). In some embodiments, the peroxide content is in a range of about 0.01 phr to about 20 phr, including about 0.1 phr to about 15 phr, and from about 0.1 phr to about 10 phr.

In some embodiments, the peroxide is selected from alkyl hydroperoxides, dialkyl peroxides, and diacyl peroxides).

Non-limiting examples of peroxides include di-t-butyl peroxide, t-butyl cumyl peroxide, dicumyl peroxide, 2,5-dimethyl-2,5-di(t-butyl-peroxy) hexyne, 3,1,3-bis(t-butyl-peroxy-isopropyl)benzene, n-butyl-4,4-bis(t-butyl-peroxy) valerate, benzoyl peroxide, t-butylperoxybenzoate, t-butylperoxy isopropyl carbonate, t-butylperbenzoate, bis(2-methylbenzoyl) peroxide, bis(4-methylbenzoyl) peroxide, t-butyl peroctoate, cumene hydroperoxide, methyl ethyl ketone peroxide, lauryl peroxide, tert-butyl peracetate, di-t-amyl peroxide, t-amyl peroxybenzoate, 1,1-bis(t-butylperoxy)-3,3,5-trimethylcyclohexane, a, a′-bis(t-butylperoxy)-1,3-diisopropylbenzene, a, a′-bis(t-butylpexoxy)-1,4-diisopropylbenzene, 2,5-bis(t-butylperoxy)-2,5-dimethylhexane, 2,5-bis(t-butylperoxy)-2,5-dimethyl-3-hexyne, and 2,4-dichlorobenzoyl peroxide.

In some embodiments, the EPDM rubber composition further includes sulfur. The sulfur may be included in an amount of from about 0 to about 10 phr, including from about 0.5 to about 5 phr, about 1 to about 3 phr, and about 1.8 phr.

The following examples are provided to illustrate the processes and compositions of the present disclosure. The examples are merely illustrative and are not intended to limit the disclosure to the materials, conditions, or process parameters set forth therein.

### EXAMPLES

Details concerning non-limiting examples of HSE EPDM are provided in Table 1. To adjust compression set, aging, surface energy, mechanical properties, extrudability and bonding quality, several industrial grade additives were used in these compounds. Curing system may rely on a sulfur cure or its combination with peroxide. Surface energy was measured according to ASTM D2578, “Standard Test Method for Wetting Tension of Polyethylene and Polypropylene Films”.

Single pass mixing was utilized, starting with all fillers, oil, then polymers, and finally the curative package.

TABLE 1
Formulation of Reference and HSE EPDM
Compounds in Parts Per Hundred (phr)

| | Reference | HSE1 | HSE2 | HSE3 |
|---|---|---|---|---|
| EPDM1 | 100 | | 80 | 80 |
| EPDM2 | | 100 | 20 | 20 |
| Paraffinic Oil | 85 | 75 | 75 | 75 |
| Carbon black | 85 | 75 | 75 | 75 |
| Filler1 | 0 | 150 | 200 | 230 |
| Filler2 | 10 | 10 | 10 | 10 |
| Calcium Carbonate | 100 | 0 | 0 | 0 |
| Stearic acid | 1 | 1 | 1 | 1 |
| Zinc oxide | 5 | 5 | 5 | 5 |
| Activator | 0 | 5 | 5 | 5 |
| Calcium Oxide | 0 | 10 | 10 | 20 |
| Process aid | 0 | 2 | 2 | 2 |
| Silane | 5 | 5 | 5 | 5 |
| Antioxidant1 | 1 | 1 | 1 | 1 |
| Antioxidant2 | 2 | 2 | 2 | 2 |
| Wax | 3 | 3 | 3 | 3 |
| Process aid | 3 | 4 | 4 | 5 |
| cure package | 3.7 | 3.7 | 3.7 | 3.7 |
| sulfur | 1.8 | 1.8 | 1.8 | 1.8 |
| Total | 405.5 | 453.5 | 503.5 | 544.5 |

EPDM1 in Table 2 is a polymer having Mooney in the range of 70-80@125° C., ethylene content 60-73%, and ENB in the range of 4.5% to 6.8%.

EPDM 2 is a polymer having Mooney in the range of 80-90, ethylene content 56-60%, and ENB in the range of 7% to 9.5%

Carbon black can be either N330 or N550 depending on mechanical property requirements.

Filler1 is a highly hygroscopic inorganic filler from the family of kaolin, talc or clay.

Filler2 is a surface treated silica.

### Extrudability

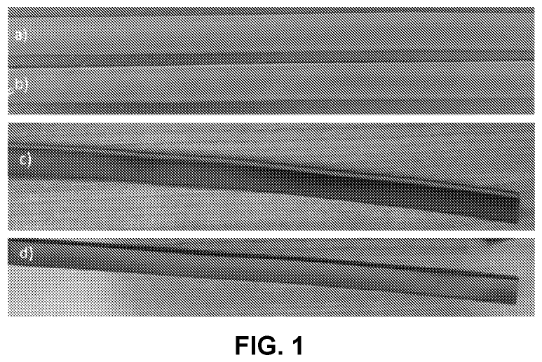

In order to investigate the extrudability of HSE EPDM compounds, a two-mm ribbon and Garvey dies were utilized according to ASTM D2230. The die swell, edge and surface quality obtained from the process are presented in FIG. 1 and Table 2.

Overall, HSE achieving a smooth surface, low die swell and sharp edges which are important for the performance, durability, productivity and aesthetic appeal of the final product. All can ensure optimal sealing performance, enhance the product's visual appearance, increase production efficiency, and improve the product's lifespan.

Table 2 presents data on the rheology, mechanical properties, and aging properties of both reference (treated an untreated) and HSE EPDM samples. The data demonstrates that HSE EPDMs have a broad range of surface energies, from 58 to 72 Dyne/cm, which makes it suitable for use with different types of adhesives as per the customers' specifications. Additionally, HSE compounds have a wide range of Mooney and scorch times that can be adjusted to meet various process conditions with minimal impact on the final production conditions. For example, the Mooney scorch of the compounds can be adjusted from 55 to approximately 70, and the t5 scorch time can be optimized between 7 to 12 minutes. The mechanical properties of all samples meet the ASTM D2000 M3BA callout, with a minimum tensile strength of 10 MPa, a minimum elongation of 400%, and a hardness of 70-74 shore A. Moreover, the excellent ozone resistance, good low-temperature properties, and low compression set make these compounds suitable for meeting the C12, F17, and F19 suffix requirements. The heat aging property of these samples shows that they meet the A14 suffix requirements, with a maximum of 10%, 18%, and 8 part changes in tensile, elongation, and hardness, respectively. Overall, these results indicate that advanced HSE EPDM compounds are highly suitable for sealing applications and meet the ASTM D2000 M3BA 710 A14 B13 C12 F17 callout.

TABLE 2
Properties of HSE EPDM compounds

| | | Reference | HSE-1 | HSE-2 | HSE-3 |
|---|---|---|---|---|---|
| Mooney | ML Scorch | 56 | 70 | 55 | 58 |
| scorch | (lb/in) | | | | |
| @ 250 F. | T5 (mins) | 8.4 | 12 | 8.9 | 6.9 |
| | T35 (mins) | 13.7 | 9.1 | 14.3 | 9.1 |
| MDR | ML (lb/in) | 1.8 | 2.5 | 1.9 | 1.8 |
| @350 F. | Ts2 (min) | 0.71 | 0.95 | 0.83 | 0.66 |
| | Tc50 (min) | 1.1 | 1.42 | 1.36 | 1.18 |
| | Tc90 (min) | 2.35 | 4.37 | 3.16 | 3.06 |
| | MH (lb/in) | 12.1 | 12.4 | 12.6 | 12.8 |
| Mechanical | Compression | 21 | 20 | 23 | 18 |
| | Set, 22 hrs, | | | | |
| | 158° F. (%) | | | | |
| | Tensile (psi) | 1679 | 1646 | 1500 | 1680 |
| | Elongation (%) | 323 | 472 | 416 | 498 |
| | 100% Modulus | 569 | 559 | 520 | 439 |
| | (psi) | | | | |
| | Durometer | 72 | 71 | 74 | 72 |
| | (Shore A) | | | | |
| Heat | Delta Tensile | | −10 | −8 | −12 |
| Aging, 70 | (%) | | | | |
| hrs @ | Delta | | −15 | −9 | −18 |
| 100 C. | elongation (%) | | | | |
| | Delta hardness | | 7 | 6 | 8 |
| | (Point) | | | | |
| | Resistance to | | 100 | 100 | 100 |
| | ozone, (%) | | | | |
| | Low- | | Pass | Pass | Pass |
| | temperature | | | | |
| | resistance | | | | |
| Extrusion | Garvey | Smooth | Smooth | Smooth | Smooth |
| | | Sharp- | Sharp- | Sharp- | Sharp- |
| | | ness | ness | ness | ness |
| | | No | No | No | No |
| | | porosity | porosity | porosity | porosity |
| | Ribbon - 2 mm | Smooth | Smooth | Smooth | Smooth |
| | | No | No | No | No |
| | | shrink- | shrink- | shrink- | shrink- |
| | | age | age | age | age |
| | | No | No | No | No |
| | | porosity | porosity | porosity | porosity |
| | Surface Energy | 32 | 58 | 62 | 72 |
| | (dyne/cm) | | | | |

### Shelf Life Test

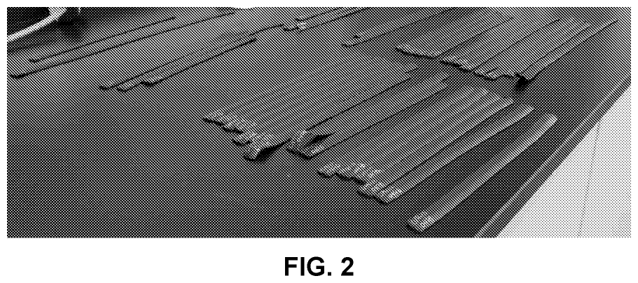

To assess the durability of surface energy over time, the extruded samples were kept at room condition for varying lengths of time, including one day, three days, one week, two weeks, three weeks, one month, and two months. FIG. 2 and Table 3 display the results. The results presented in Table 3 demonstrate that the surface chemistry of all samples remained stable throughout the aging period, and the surface energy does not change over time. For instance, the surface energy of HSE-1, HSE-2 and HSE-3 EPDM, which initially measured 58, 60 and 72 dyne/cm, respectively, remained unchanged even after two months. The important characteristic of HSE compounds provides a significant safety shelf-life between the extrusion process and the ultimate use, ensuring certain that the surface energy and peel strength remain intact during this period.

TABLE 3
Effect of shelf life on Surface energy of HSE compounds

| | Shelf life (days) | | | | | | |
|---|---|---|---|---|---|---|---|
| Sample | 1 | 3 | 7 | 14 | 21 | 30 | 60 |
| Reference | 30 | 30 | 30 | 30 | 30 | 30 | 30 |
| Surface treated sample | 72 | 60 | 60 | 60 | 58 | 58 | 58 |
| HSE compound | 72 | 72 | 72 | 72 | 72 | 72 | 72 |

### Peeling Test

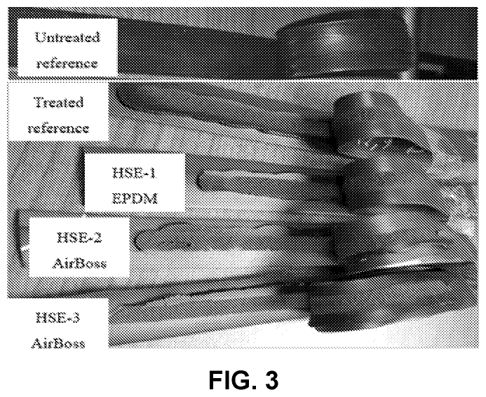

To study the adhesive/rubber bond strength, Peel test was studied for HSE EPDM, and references and the results are shown in FIG. 3 and Table 4. It shows that the non-treated reference EPDM experienced adhesive failure, while all HSE EPDM samples and treated reference exhibited cohesive failure. This indicates an inadequate adhesion bond in the untreated sample and a strong bond in HSE EPDMs and treated samples. Based on the quantity studies, untreated reference, treated reference, HSE1, HSE-2, and HSE-3 samples exhibited peel strengths of 14, 28, 40, 68, and 75 psi/inch, respectively, which are associated with the surface energy of the samples. The findings demonstrate that surface treatment of EPDM has a positive impact on both surface energy and bond strength. Nonetheless, AirBoss HSE technology produces even higher surface energy and stronger bonding than the treated surface.

TABLE 4
Peel test of EPDM samples

| | Energy | Peel | Failure |
|---|---|---|---|
| Sample | (Dyne/cm) | strength | mode |
| Untreated | 30 | 14 | Adhesive |
| reference | | | |
| Treated reference | 60 | 28 | Cohesive |
| HSE-1 | 58 | 40 | Cohesive |
| HSE-2 | 62 | 68 | Cohesive |
| HSE-3 | 72 | 75 | Cohesive |

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A high surface energy EPDM rubber composition comprising:
from about 0 to about 90 phr of a first EPDM polymer having a Mooney viscosity measured at 125° C. in the range of 70 to 80, and/or an ethylene content in a range of about 60 to 73%, and/or a diene content in a range of about 4.5 to 6.8%;
and from about 10 to about 100 phr of a second EPDM polymer having a Mooney viscosity measured at 125° C. in the range of 80 to 90, and/or an ethylene content in a range of about 50 to 60%, and/or a diene content in a range of about 7 to 9.5%.

2. The high surface energy EPDM rubber composition of claim 1, further comprising:
from about 100 to about 300 phr of a highly hygroscopic inorganic filler.

3. The high surface energy EPDM composition of claim 2, wherein the highly hygroscopic inorganic filler is included in an amount of about from 150 to about 230 phr.

4. The high surface energy EPDM composition of claim 1, further comprising:
calcium oxide.

5. The high surface energy EPDM composition of claim 2, further comprising:
calcium oxide.

6. The high surface energy EPDM composition of claim 3, further comprising:
calcium oxide.

7. The high surface energy EPDM composition of claim 4, wherein the calcium oxide is included in an amount of from about 5 to about 30 phr.

8. An article comprising the high surface energy EPDM composition of claim 1 adhered to a substrate with an adhesive.

9. The article of claim 8, wherein the substrate comprises glass.

10. The article of claim 8, wherein the substrate comprises a metal or a metal alloy.

11. The article of claim 8, wherein the adhesive comprises an epoxy adhesive.

12. The article of claim 8, wherein the adhesive comprises a polyurethane adhesive.

13. A high surface energy EPDM rubber composition comprising:
an EPDM polymer having a Mooney viscosity measured at 125° C. in the range of 80 to 90, and/or an ethylene content in a range of about 50 to 60%, and/or a diene content in a range of about 7 to 9.5%;
a highly hygroscopic inorganic filler; and
calcium oxide.

14. The high surface energy EPDM rubber composition of claim 13, wherein the diene is ENB.

15. A high surface energy EPDM rubber composition comprising an EPDM polymer having a Mooney viscosity measured at 125° C. in the range of 80 to 90, and/or an ethylene content in a range of about 50 to 60%, and/or a diene content in a range of about 7 to 9.5%.

16. The high surface energy EPDM rubber composition of claim 15, wherein the diene is ENB.

17. The high surface energy EPDM rubber composition of claim 15 comprising a highly hygroscopic inorganic filler.

18. The high surface energy EPDM rubber composition of claim 17, wherein the highly hygroscopic inorganic filler is from the family of kaolin, talc, or clay.

19. The high surface energy EPDM rubber composition of claim 15 having a minimum surface energy level of 58 dynes/cm.

20. The high surface energy EPDM rubber composition of claim 15 comprising calcium oxide.
